(19) United States
(12) Patent Application Publication
(10) Pub. No.: US 2010/0091131 A1
(43) Pub. Date: Apr. 15, 2010

(54) IMAGING SYSTEM AND STORAGE MEDIUM STORING AN IMAGING PROGRAM

(75) Inventor: Eiji FURUKAWA, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/635,368

(22) Filed: Dec. 10, 2009

Related U.S. Application Data
(63) Continuation of application No. PCT/JP2008/060929, filed on Jun. 10, 2008.

(30) Foreign Application Priority Data
Jun. 11, 2007 (JP) 2007-154097

(51) Int. Cl. H04N 5/225

(52) U.S. Cl. 348/222.1; 348/E05.024

(57) ABSTRACT

An imaging system which captures an image and generates image data of the image, includes: a capture instruction input unit through which a first stage capture instruction and a following second stage capture instruction are input; a capture unit which performs earlier capture processing for capturing a plurality of images during a period from when the first stage capture instruction is input and until the second stage capture instruction is input, and performs later capture processing for capturing a plurality of images after the second stage capture instruction is input; and an image displacement amount estimation unit which estimates an image displacement amount between a reference image and each of the plurality of images captured in the earlier capture processing and the later capture processing, using one of the images captured during a prescribed period which is a predetermined period including before and after the second stage capture instruction is input, as the reference image.

### CROSS REFERENCE TO RELATED APPLICATIONS

This application is a continuation of International Patent Application No. PCT/JP2008/060929, filed on Jun. 10, 2008, which claims the benefit of Japanese Patent Application No. JP 2007-154097, filed on Jun. 11, 2007, which are incorporated by reference as if fully set forth.

### FIELD OF THE INVENTION

The present invention relates to an imaging system and an imaging program. In particular, the present invention relates to an imaging system which captures a plurality of images and estimates image displacement amounts between the plurality of images, and the like.

### BACKGROUND OF THE INVENTION

In a digital camera disclosed in JP2005-94288A (page 1 and FIG. 3), a plurality of images that have higher resolution than normal images are captured and recorded into an internal memory while a user half-presses the shutter button. If the user fully-presses the shutter button, the digital camera records a high-resolution image captured during the half-pressing, which is done immediately before the full-pressing, into a memory pack as a non-provisional image, whereby a time lag between an image for displaying on the liquid crystal display panel and the non-provisional image upon pressing the shutter is reduced.

Moreover, WO04/63991 discloses a technique for performing registration (alignment) of a plurality of low resolution images by estimating image displacement amounts between the plurality of images by a sub-pixel matching.

Furthermore, WO04/68862 discloses a technique for generating a single high-resolution image from a plurality of low resolution images by super-resolution processing.

An image system according to one aspect of this invention, which captures an image and generates image data of the image, comprising: a capture instruction input unit through which a first stage capture instruction and a following second stage capture instruction are input; a capture unit which performs earlier capture processing for capturing a plurality of images during a period from when the first stage capture instruction is input and until the second stage capture instruction is input, and performs later capture processing for capturing a plurality of images after the second stage capture instruction is input; and an image displacement amount estimation unit which estimates an image displacement amount between a reference image and each of the plurality of images captured in the earlier capture processing and the later capture processing, using one of the images captured during a prescribed period which is a predetermined period including before and after the second stage capture instruction is input, as the reference image.

A computer readable storage medium according to another aspect of this invention stores an imaging program. The imaging program instructs a computer to execute a method comprising: an image data acquisition step of acquiring image data of a plurality of images from an imaging system which captures a plurality of images before and after a shutter button is fully-pressed; a reference image determination step of automatically determining a reference image from the images captured in a prescribed period which is a predetermined period including before and after a time when the shutter button is fully-pressed; and an image displacement amount estimation step of estimating an image displacement amount between the reference image and each of the plurality of images captured before and after the shutter button is fully-pressed.

The embodiments and advantageous characteristics of the present invention will be described in detail below with reference to the attached drawings.

### BRIEF DESCRIPTION OF THE DRAWINGS

FIG. 1 is a block diagram showing an arrangement of an imaging system according to the first embodiment.

FIG. 2 is a rear elevation view showing an external appearance configuration of the imaging system according to the first embodiment.

FIG. 3 is a flow chart showing processing performed in the imaging system according to the first embodiment.

FIG. 4 is a flow chart showing the details of determination processing for determining a prescribed number of images to be captured in an earlier capture and a later capture in the first embodiment.

FIG. 5 is a flow chart showing the details of earlier capture processing in the first embodiment.

FIG. 6 is a flow chart showing the details of later capture processing in the first embodiment.

FIG. 7 is a view showing an example of a preparation completion notification of the later capture in the first embodiment.

FIG. 8 is a view showing a processing sequence of the imaging system according to the first embodiment.

FIG. 9 is a flow chart showing an algorithm of processing for estimating image displacement amounts which is performed in an image displacement amount estimation unit.

FIG. 10 is a view showing an example of a similarity curve obtained in the processing for estimating the image displacement amounts.

FIG. 11 is a flow chart showing an algorithm of high-resolution processing performed in the high-resolution processing unit.

FIG. 12 is a block diagram showing an example of an arrangement of the high-resolution processing unit.

FIGS. 13A-13D are views showing examples of a method for automatically determining a reference image in the imaging system according to the second embodiment.

FIG. 14 is a view showing a processing sequence of the imaging system according to the third embodiment.

FIG. 15 is a view illustrating high-resolution processing in the imaging system according to the fourth embodiment.

FIG. 16 is a view showing a processing sequence of the imaging system according to the fifth embodiment.

FIG. 17 is a graph showing a relationship between the magnification ratio of the high-resolution image and the number of images to be used in the high-resolution processing in the imaging system according to the sixth embodiment.

### DESCRIPTION OF THE PREFERRED EMBODIMENT

### First Embodiment

Hereafter, the imaging system according to the first embodiment of the present invention will be described with reference to the drawings.

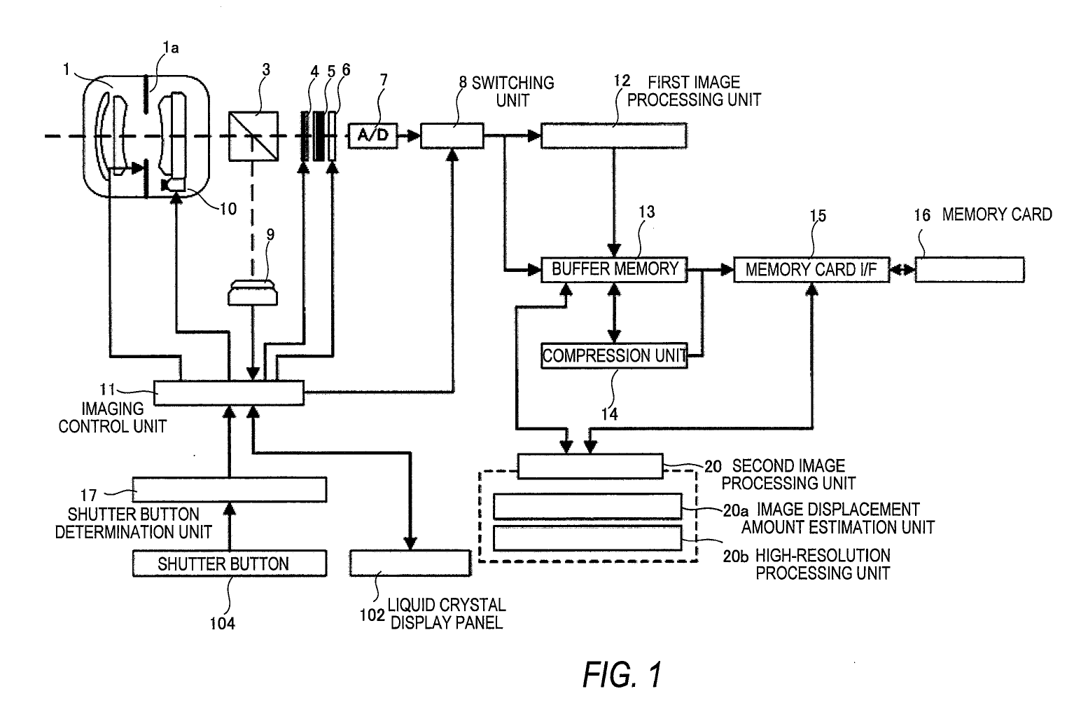

FIG. 1 depicts a block diagram showing an arrangement of the imaging system according to the first embodiment of the present invention. An electronic still camera (digital still camera) which captures still images is shown in FIG. 1 as an example of an imaging system. However, it may be an electronic camera (digital camera) which is capable of capturing motion pictures in addition to still images. Moreover, the arrangement of the imaging system is not limited to an arrangement shown in FIG. 1, and other components may be added if necessary and unnecessary components may be omitted.

The imaging system according to the present embodiment includes a lens system 1 which includes a diaphragm 1a, a spectral half-mirror system 3, a shutter 4, a lowpass filter 5, a CCD (charge coupled devices) imaging device 6, an analog-to-digital (A/D) conversion circuit 7, a switching unit 8, and an AE (automatic exposure) photosensor 9, an AF (auto focus) motor 10, an imaging control unit 11, a first image processing unit 12, a buffer memory 13, a compression unit 14, a memory card I/F (interface) 15, a memory card 16, a shutter button determination unit 17, a second image processing unit 20, a liquid crystal display panel 102, and a shutter button (capture instruction input unit) 104. The lens system 1, the spectral half-mirror system 3, the shutter 4, the lowpass filter 5, the CCD imaging device 6, the A/D conversion circuit 7, the switching unit 8, the AE photosensor 9, the AF motor 10, the imaging control unit 11, the first image processing unit 12, the buffer memory 13, the compression unit 14, and the like configure a capture unit which performs earlier capture processing and later capture processing, which will be described later.

The lens system 1 which includes the diaphragm 1a, the spectral half-mirror system 3, the shutter 4, the lowpass filter 5, and the CCD imaging device 6 are arranged along an optical axis. A single CCD imaging device is used as the CCD imaging device 6 in the first embodiment. However, for example, a CMOS imaging device may be used instead of the CCD imaging device 6. A light flux branched from the spectral half-mirror system 3 is guided to the AE photosensor 9. Connected to the lens system 1 is the AF motor 10 for moving a part of the lens system during the focusing work. Signals from the CCD imaging device 6 are fed into the buffer memory 13 through the A/D conversion circuit 7, the switching unit 8, and the first image processing unit 12, or alternatively, directly fed from the switching unit 8 into the buffer memory 13, without passing through the first image processing unit 12.

The buffer memory 13 is capable of performing input and output of image data to and from the compression unit 14 and the second image processing unit 20, and is also used as a work buffer in each processing. The image data saved in the buffer memory 13 is fed and recorded into a removable memory card 16 through the memory card I/F 15.

Signals from the AE photosensor 9 are fed to the imaging control unit 11. The imaging control unit 11 controls the diaphragm 1a based on signals from the AE photosensor 9, and also controls the AF motor 10, the CCD imaging device 6, and the switching unit 8. Moreover, the shutter button determination unit 17 determines the state of the shutter button 104, and feeds the determined result into the imaging control unit 11. Furthermore, signals from the imaging control unit 11 are fed into the liquid crystal display panel 102.

The second image processing unit 20 includes an image displacement amount estimation unit 20a and a high-resolution processing unit 20b. Moreover, the second image processing unit 20 is capable of performing input and output of the image data to and from the buffer memories 13, and is also capable of performing input and output of the image data to and from the memory card 16 through the memory card I/F 15.

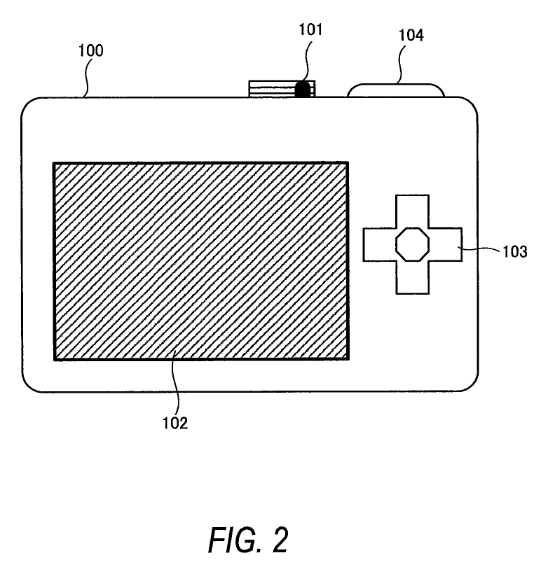

FIG. 2 depicts a rear elevation view showing an external appearance configuration of the imaging system according to the first embodiment of the present invention. The imaging system according to the present embodiment is an electronic still camera, and has a camera body 100, a power switch 101 provided in the camera body 100, a liquid crystal display panel 102, an operation button 103, and a shutter button 104.

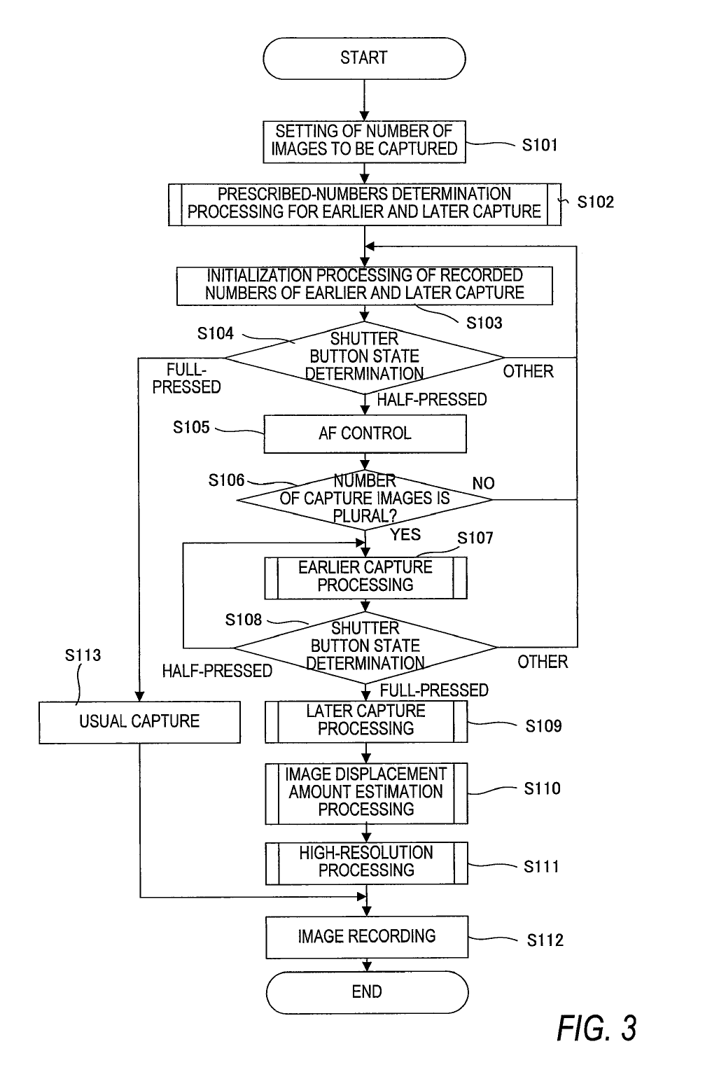

FIG. 3 depicts a flow chart showing processing performed in the imaging system according to the first embodiment of the present invention. The imaging system according to the present embodiment captures and records images in order to obtain a plurality of images needed for high-resolution processing (S111), which will be described later. The number of capture images (number of images to be captured) is set in the number-of-capture-images setting (S101). The prescribed-numbers determination processing (S102) for earlier and later capture is performed based on the number of images set by the user in the number-of-capture-images setting (S101), to thereby determine the numbers of images to be captured and recorded in the earlier capture processing (S107) and the later capture processing (S109), which will be described later.

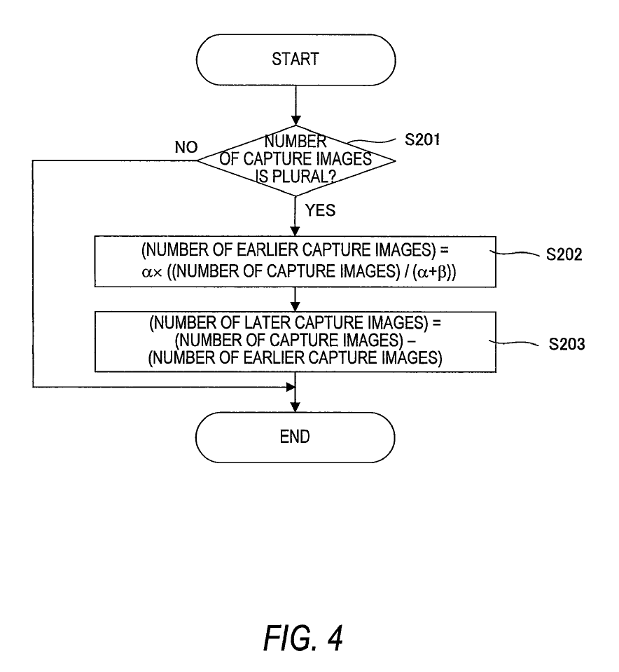

FIG. 4 is a flow chart showing the details of the prescribed-numbers determination processing (S102) for the earlier and later capture. Now, the prescribed-numbers determination processing (S102) for the earlier and later capture will be described. As shown in FIG. 4, it is determined whether or not the number of images set in the number-of-capture-images setting (S101) is a plural number (S201). If the set number is one, the process ends. If the set number of images is a plural number, the number of earlier capture images to be captured and recorded in the earlier capture processing (S107) and the number of later capture images to be captured and recorded in the later capture processing (S109) are calculated by the following Expression (1) and Expression (2) (S202, S203), and the process ends.

(number of earlier capture images)=α×((number of capture images)/(α+β)) (1)

(number of later capture images)=(number of capture images)−(number of earlier capture images) (2)

In the present embodiment, α and β in Expression (1) are set beforehand. In the number-of-capture-images setting (S101), it may be configured such that the number of earlier capture images and the number of later capture images are directly specified. Moreover, the number of capture images set in the number-of-capture-images setting (S101) and the set values of α and β may depend on the scene which the user is going to shoot. For example, when the user specifies with an operation of the operation button 103 that the user is going to shoot a scene in which motion of the photographic subject is rapid, the number of capture images may be set to increase, or a may be set to a relatively large value.

After the prescribed-numbers determination processing (S102) for the earlier and later capture, the recorded number of earlier and later capture images recorded in the buffer memory 13 is initialized to zero (103), and the state determination of the shutter button 104 is performed (S104). If the shutter button 104 is in a fully-pressed state, a single usual capture is performed (S113), and the image data of the captured image is recorded (S112), and the process ends. If the shutter button 104 is in a half-pressed state, the AF control (S105) is performed. Thereafter, it is determined whether or not the number of capture images is a plural number (S106). If the number of capture images is a plural number, a plurality of images are captured and recorded in the earlier capture processing (S107).

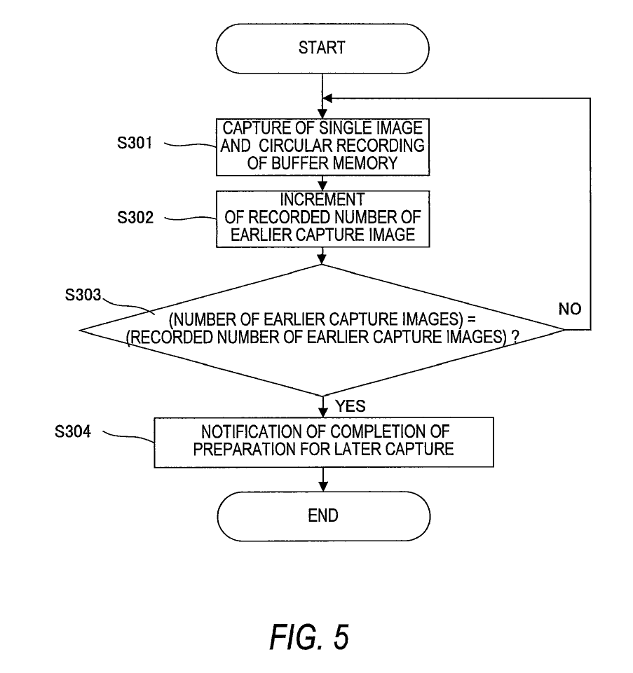

FIG. 5 is a flow chart showing the details of the earlier capture processing (S107). Now, the earlier capture processing (S107) will be described. As shown in FIG. 5, first, the image data of an image captured by performing a single image capture is circular-recorded into the buffer memory 13 (S301). The “circular recording” herein indicates to circularly record image data of a predetermined number of images, such as image data for the number of the earlier capture images determined in the prescribed-numbers determination processing (S102), while overwriting image data of an old image with image data of a new image. The buffer memory 13 has a storage area which can record the image data of a predetermined number of images among a plurality of images captured in the earlier capture processing (S107). For example, if the image data of the predetermined number of images is already recorded, the image data is circular-recorded by overwriting from the oldest image data among the recorded image data. Thereby, it is possible to save the capacity of the memory.

Thereafter, the recorded number of earlier capture images is incremented (S302). It is determined whether or not the number of the earlier capture images determined in the prescribed-numbers determination processing (S102) in FIG. 3 and the incremented recorded number of earlier capture images have become equal (S303). Until they are equal, the single capture and the circular recording (S301) and the increment of the recorded number of earlier capture images (S302) are repeated. When the determined number of earlier capture images and the recorded number of earlier capture images become the same, the notification of the completion of preparation of the later capture (S304) is provided to the user. As for the way to provide the notification, it may be done by displaying the notification of completion in the liquid crystal display panel 102 in FIG. 2, and for example, it may be done by using sounds.

After the earlier capture processing (S107), the state of the shutter button 104 (S108) is determined. If the shutter button is in a half-pressed state, the earlier capture processing (S107) is repeated, and if the shutter button is in a full-pressed state, a plurality of images are captured and recorded in the later capture processing (S109). If the shutter button is in other state, such as a state where the user is releasing the shutter button 104, the processing returns to the initialization processing of the recorded numbers of earlier and later capture images (S103).

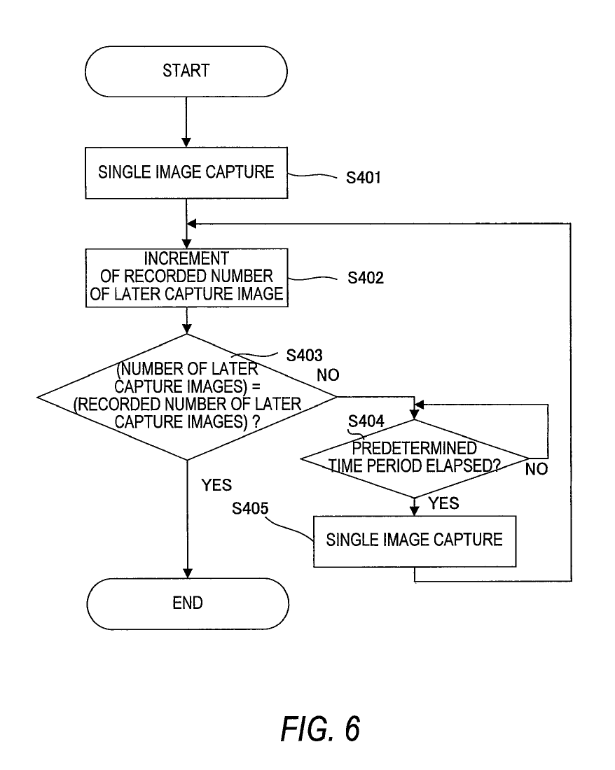

FIG. 6 depicts a flow chart showing the details of the later capture processing (S109). Now, the later capture processing (S109) will be described. In the present embodiment, capture of m images (S401) is first performed in the later capture processing (S109). The timing of the capture of the m images is immediately after the user has fully-pressed the shutter button 104. In the present embodiment, the case of m=1 will be described. However, m may be 2 or more according to the performance of the imaging device and the above-described scenes for the capture. Moreover, the user may specify the value of m by operating the operation button 103. After the capture of the first image (S401), a recorded number of later capture images is incremented (S402). It is determined whether or not the number of later capture images determined in the prescribed-numbers determination processing (S102) and the incremented recorded number of later capture have become equal (S403). If not, the single image capture (S405) and the increment of the recorded number of later capture images (S402) are repeated. Upon the iteration, for example, one storage area of the buffer memory 13 is assigned for the earlier capture processing and another storage area of the buffer memory 13 is assigned for the later capture processing, whereby each assigned storage area is used for the respective capture processing.

Moreover, in the present embodiment, m images (as described above, m=1 in the present embodiment) are captured immediately after the full-pressing (S401) in the later capture processing (S109). Thereafter, it is determined whether or not a predetermined time period t has elapsed since the shutter button 104 is fully-pressed (S404), and the capture of the image is halted until a predetermined time period t elapses. If it is determined that the predetermined time period t has elapsed since the shutter button 104 had been fully-pressed in S404, the capture of the second image and subsequent images starts. The predetermined time period t for halting the capture is set in advance. For example, the predetermined time period t may be set as a time period during which the amount of camera shake upon the shutter button 104 being fully-pressed is considered large. Therefore, the predetermined time period t is set to a suitable value according to the above-described scenes to be shot.

After the later capture processing (S109), the image displacement amount estimation processing (S110) and the high-resolution processing (S111) are performed, whereby the high-resolution image generated in the high-resolution processing (S112) is recorded, and the processing ends. The image displacement amount estimation processing (S110) and the high-resolution processing (S111) will be described later.

Now, the above-described processing performed in the imaging system according to the present embodiment will be described in more detail along with the flow of the image signal (image data). First, by the user pushing the shutter button 104 after turning the power switch 101 to the ON state, the imaging control unit 11 controls the diaphragm 1a, the shutter 4, and the AF motor 10, etc., whereby images are captured. In capturing images, image signals from the CCD imaging device 6 are converted into digital signals in the A/D conversion circuit 7, and are output to the buffer memory 13 as image signals of RGB (red, green, blue) which had been subjected to well-known white balance, emphasis processing, interpolation processing, and the like, by the first image processing unit 12.

In S104 of FIG. 3, if the shutter button 104 is half-pressed, the AF control (S105) is performed. By converting the output signals from the CCD imaging device 6 into digital signals in the A/D conversion circuit 7, the focus position of the AF control is obtained by calculating luminance signals from image signals of a single plate state (for example, by using only the G component), and acquiring edge intensities in the luminance signals. That is, by changing the focus position of the lens system 1 gradually with the AF motor 10, the focus position which gives the largest edge intensity can be estimated.

Then, after locking the AF, the earlier capture processing (S107) is performed during the time period when the shutter button 104 is half-pressed. For example, the circular recording of the image data is performed using a storage area for the number of earlier capture images, which is maintained in the buffer memory 13. Upon the circular recording, the image signals converted into digital signals in the A/D conversion circuit 7 are recorded into the buffer memory 13 through the first image processing unit 12. When the image data for the number of earlier capture images is recorded into the buffer memory 13, the imaging control unit 11 outputs signals for issuing the notification of the completion of preparation for the later capture, and for example, the notification of the completion of preparation for the later capture is displayed in the liquid crystal display panel 102.

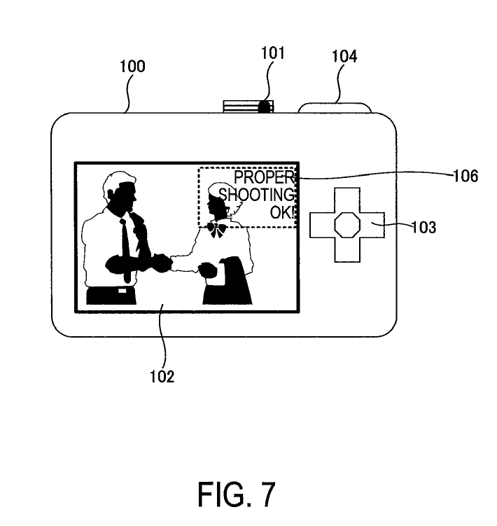

FIG. 7 depicts a view showing an example of the notification of the completion of preparation for the later capture. In the example shown in FIG. 7, the user is notified by displaying the later capture preparation completion notification 106 showing “PROPER SHOOTING OK!” in the liquid crystal display panel 102.

After the notice of the completion of preparation for the later capture, when the user fully-presses the shutter button 104, the imaging control unit 11 performs the later capture processing (S109). In the later capture processing (S109), image signals of a first image, which is captured first, are saved into the buffer memory 13 through the first image processing unit 12, and it is determined in the imaging control unit 11 whether or not a predetermined time period t has elapsed since the shutter button 104 is fully-pressed (S404). The capture of the image is halted from the shutter button 104 is fully-pressed until the predetermined time period t elapses. When the predetermined time period t has elapsed, the second and subsequent captures in the later capture processing (S109) are started, and image signals of the second and the subsequent images are also saved at the buffer memory 13 through the first image processing unit 12. The image data saved in the buffer memory 13 is subjected to an image compression, such as JPEG, in the compression unit 14, and the compressed image data is recorded into the memory card 16 from the buffer memory 13 via the memory card I/F 15 using the buffer memory 13 as a work buffer.

The second image processing unit 20 is capable of performing input and output of the image data to and from the memory card 16 via the memory card I/F 15, and is also capable of performing input and output of the image data to and from the buffer memory 13. For this reason, if the buffer memory 13 has large capacity, the compressed image data and the image data before being compressed may not be recorded into the memory card 16 so that these pieces of image data are recorded into the buffer memory 13, and only the image data of the high-resolution image generated in the high-resolution processing unit 20b may be recorded into the memory card 16 from the buffer memory 13.

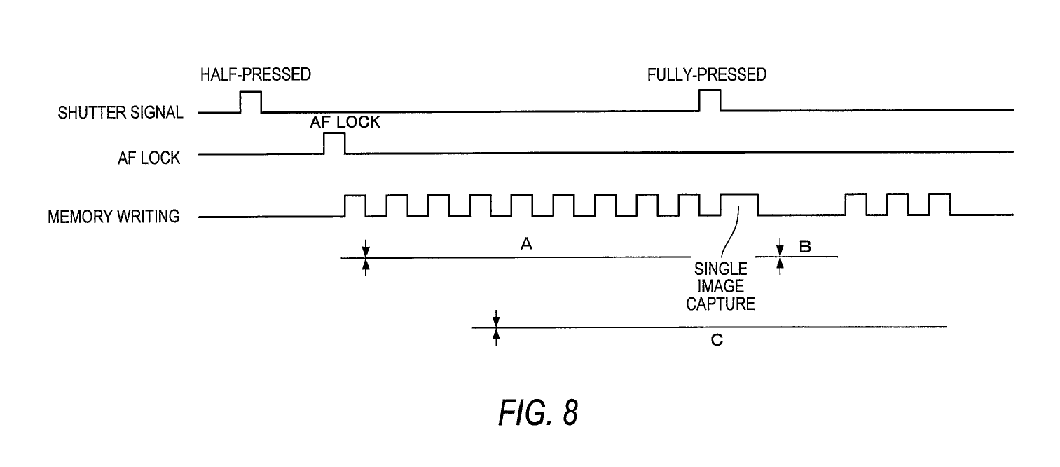

FIG. 8 depicts a view showing a processing sequence of the imaging system according to the first embodiment of the present invention. In the present embodiment, as described above, after the shutter button 104 is half-pressed and AF is locked, the earlier capture processing (S107) is performed, for example, during the period shown at “A” in FIG. 8, and the circular recording is performed while image data for the number of earlier capture images is maintained in the buffer memory 13. Then, immediately after the shutter button 104 is fully-pressed, a single image capture (S401) in the later capture processing (S109) is performed, and thereafter, the capture of the image is halted, for example, during the period shown at “B” in FIG. 8. Thereafter, the capture of the second and subsequent images in the later capture processing (S109) is performed, and the image data for the number of later capture images is recorded in the buffer memory 13. The period “C” in FIG. 8 shows a period during which the image data used for the image displacement amount estimation processing (S110), which will be described later, is recorded. After performing the processing shown in FIG. 8, the image displacement amount estimation processing (S110) and the high-resolution processing (S111) are performed using the image data for the number of images required for the high-resolution processing (S111).

Now, the image displacement amount estimation processing (S110) and the high-resolution processing (S111) which are performed in the second image processing unit 20 will be described. The second image processing unit 20 first estimates the image displacement amount between the images (correspondence of the pixel positions between the images) in the image displacement amount estimation unit 20a. Then, the second image processing unit 20 generates a high-resolution image in the high-resolution processing unit 20b using the pixel displacement amount and the image data obtained in the earlier capture processing (S107) and the later capture processing (S109).

First, the image displacement amount estimation processing (S110) will be described. The image displacement amount estimation unit 20a sets an image captured in a prescribed period which is a predetermined period before and after the shutter button 104 is fully-pressed (i.e., predetermined period including a time when the shutter button 104 is fully-pressed), as a reference image. The image displacement amount estimation unit 20a estimates the image displacement amount between the reference image and each of the plurality of images captured in the earlier capture processing (S107) and the later capture processing (S109). In the present embodiment, an image captured immediately after the shutter button 104 is fully-pressed is used as the reference image. In this case, the above-described prescribed period is a period from just before the shutter button 104 is fully-pressed until the first image is captured.

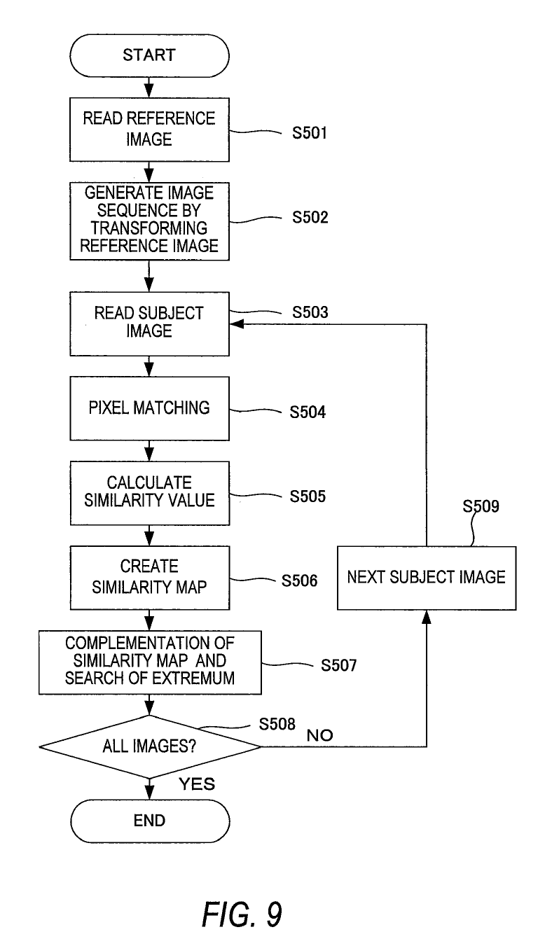

FIG. 9 depicts a flow chart showing an algorithm of image displacement amount estimation processing (S110) performed in the image displacement amount estimation unit 20a. Hereafter, the image displacement amount estimation processing (S110) will be described along with the flow of the algorithm shown in FIG. 9. First, a single image to be used as a reference of the image displacement amount estimation is read as the reference image (S501). In the present embodiment, the image captured immediately after fully-pressing the shutter button 104 is used as the reference image. Next, the reference image is transformed with a plurality of image transformation parameters, whereby an image sequence is generated (S502). At this time, the image sequence is generated by, for example, shifting translationally or rotating the reference image in a predetermined range. Thereafter, as the subject image to be subjected to the image displacement amount estimation with the reference image, a single image among the plurality of images captured in the earlier capture processing (S107) and the later capture processing (S109) is read (S503). Then, a rough correspondence of the pixel positions is searched between the reference image and the subject images by using a pixel matching technique, such as an area-based matching technique (S504). Thereby, the image displacement amount between the reference image and the subject images is obtained in pixel level.

Next, similarity values between the image sequence generated by transforming the reference image in S502 and the subject images are computed (S505). The similarity value can be obtained as the difference between the image of the image sequence and the subject image, such as SSD (Sum of Squared Difference) and SAD (Sum of Absolute Difference). Then, a discrete similarity map is created using a relationship between the image transformation parameter at the time of generating the image sequence in S502, and the similarity value computed in S505 (S506). From the discrete similarity map, a continuous similarity curve is obtained by complementing the discrete similarity map created in S506, and the extremum of the similarity value is searched in the continuous similarity curve (S507). Examples of the methods to obtain of the continuous similarity curve by complementing the discrete similarity map include a parabola fitting technique and a spline interpolation technique. The image transformation parameter where the similarity value becomes the extremum in the continuous similarity curve is estimated as the image displacement amount between the reference image and the subject images.

Thereafter, it is determined whether or not the image displacement amount estimation is performed for all the images to be used in the high-resolution processing (S111) (S508). If the image displacement amount estimation is not performed for all the images, another image among the plurality of images captured in the earlier capture processing (S107) and the later capture processing (S109) is set as the next image (S509), and then the processing from S503 to S508 is repeated. In the present embodiment, the image displacement amount is estimated for all the images captured in the earlier capture processing (S107) and the later capture processing (S109), and recorded into the buffer memory 13. However, the image displacement amount may be estimated for only a part of the plurality of images recorded in the buffer memory 13. In S508, if it is determined that the image displacement amount estimation is performed for all the images which are to be used in the high-resolution processing (S111), the processing ends.

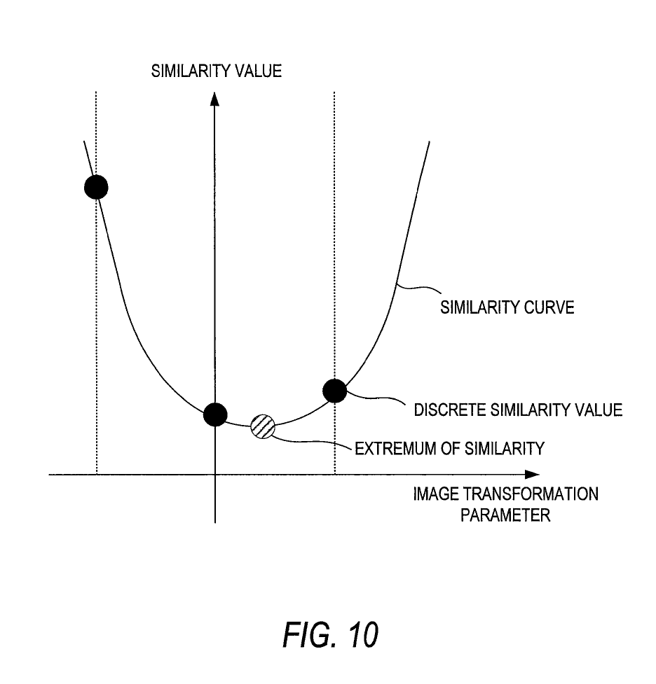

FIG. 10 depicts a view showing an example of a similarity curve obtained in S507 of the image displacement amount estimation processing (S110). In FIG. 10, the vertical axis represents similarity values, and the horizontal axis represents image transformation parameters at the time of the generation of the image sequence in S502 of FIG. 9. In the example in FIG. 10, the similarity between the image sequence and the subject images is computed by SSD, and the similarity curve is obtained by complementing the discrete similarity map with a parabola fitting technique. The smaller the similarity value is, the higher the similarity becomes. Thus, a continuous similarity curve is obtained by complementing the discrete similarity map, and the extremum (local minimum value in the example in FIG. 10) is searched, to thereby obtain the image displacement amount between the reference image and each of the subject images at a sub-pixel level.

Thus, the image displacement amount estimated in the image displacement amount estimation unit 20a and the image data of the image for which an image displacement amount is obtained are transferred to the high-resolution processing unit 20b, and the reference image is subjected to the high-resolution processing (S111) using super-resolution processing.

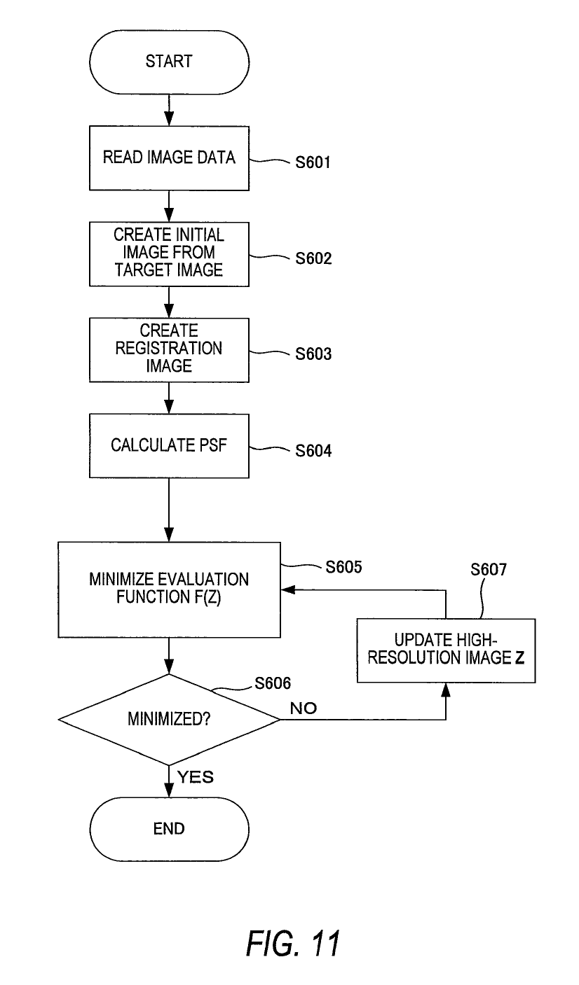

FIG. 11 is a flow chart showing an algorithm of the high-resolution processing (S111) performed in the high-resolution processing unit 20b. Now, the high-resolution processing (S111) using the super-resolution processing will be described along with the flow of the algorithm shown in FIG. 11. First, the image data of the reference image and the image data of the plurality of subject images for which the image displacement amount is estimated in the image displacement amount estimation processing (S110), are read (S601). The reference image is used as a target image of the high-resolution processing. The target image is subjected to complement processing, such as bi-linear interpolation and bi-cubic interpolation, whereby an initial image z₀ is created (S602). The interpolation processing may be omitted according to the circumstances.

Then, the relationship of the pixel correspondences between the target image and the image for which the image displacement amount is estimated in the image displacement amount estimation processing (S110) is represented by the image displacement amount estimated in the image displacement amount estimation unit 20a. Using the image displacement amount, these images are aligned and superposed in a coordinate space which is based on the expanded coordinates (magnified coordinates) of the target image, whereby the registration image y is generated (S603). Here, y is a vector representing image data of the registration image. The details of the method of generating the registration image y is disclosed in “M. Tanaka and M. Okutomi, Fast Algorithm for Reconstruction-based Super-resolution, Computer Vision and Image Media (CVIM) Vol. 2004, No. 113, and pp. 97-104, (2004-11)”. For example, in the superposition processing in S603, each pixel of the plurality of subject images for which the image displacement amount is estimated in the image displacement amount estimation processing (S110), is fitted to the pixel positions of the expanded coordinates of the target image, and thereby, each pixel is arranged on the nearest lattice point of the expanded coordinates of the target image. Here, there are cases where a plurality of pixel values is set on the same lattice point. If so, the averaging is performed to the plurality of pixel values.

Next, the point spread function (PSF) is obtained in consideration of the capture characteristics, such as the optical transfer function (OTF) and the CCD aperture (CCD opening) (S604). The PSF is reflected in the matrix A in the following Expression (3). For example, a Gaussian function may be used for simplicity. Thereafter, the minimization of the evaluation function f(z) represented by the following Expression (3) is performed using the registration image y generated in S603 and the PSF obtained in S604 (S605). Furthermore, it is determined whether or not f(z) is minimized (S606).

f(z)=∥y−Az∥²+λg(z) (3)

In Expression (3), y is a column vector representing image data of the registration image generated in S603, z is a column vector representing image data of a high-resolution image obtained by subjecting the target image to high-resolution processing, and A is an image transformation matrix representing the characteristics of the imaging system including PSF and the like. Moreover, g(z) is a regularized term in consideration of the smoothness of the image, correlation of the color of the image, and the like, and λ is a weighting factor. For example, a steepest descent method can be used for the minimization of the evaluation function f(z) represented by Expression (3). In cases where the steepest descent method is used, the value derived by performing partial differentiation of f(z) with each element (component) of z is calculated, and the vector which has those values as elements is generated. As shown in the following Expression (4), a vector that has the values derived by the partial differentiation as elements is added to z, and thereby, the high-resolution image z is repeatedly updated (S607) and z that derives the minimum f(z) is obtained.

$${z}_{n + 1} = {z}_{n} + α \frac{\partial f ( z )}{\partial z} \qquad ( 4 )$$

In Expression (4), zₙ is a column vector representing the image data of the high-resolution image that was subjected to n times of updating, and a is a step size of the update amount. In the first processing of S605, the initial image z₀ obtained in S602 can be used as the high-resolution image z. If it is determined that f(z) is minimized in S606, the processing ends, and zₙ at that time is recorded as a final high-resolution image in the memory card 16 or the like. Thus, it is possible to obtain a high-resolution image having higher resolution than the plurality of images captured in the earlier capture processing (S107) and the later capture processing (S109).

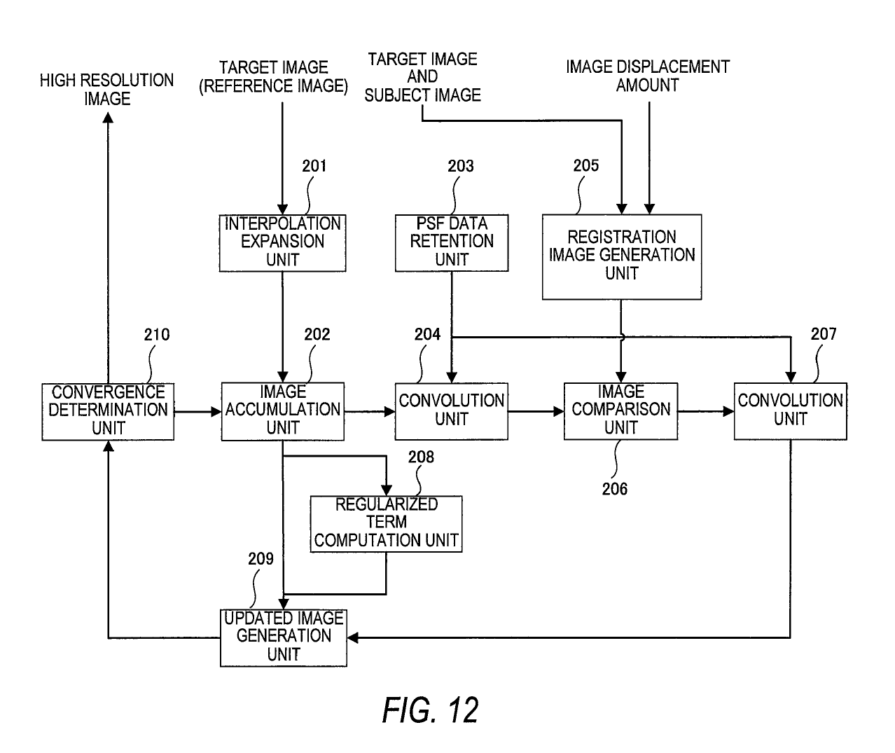

FIG. 12 depicts a block diagram showing an example of an arrangement of the high-resolution processing unit 20b. Here, the high-resolution processing (S111) using the super-resolution processing performed in the high-resolution processing unit 20b will be described further. The high-resolution processing unit 20b shown in FIG. 12 includes an interpolation expansion unit 201, an image accumulation unit 202, a PSF data retention unit 203, a convolution unit 204, a registration image generation unit 205, an image comparison unit 206, a convolution unit 207, a regularized term computation unit 208, an updated image generation unit 209, and a convergence determination unit 210.

First, a reference image captured during the prescribed period, which is a predetermined period including before and after the shutter button 104 is fully-pressed, is supplied to the interpolation expansion unit 201, whereby an interpolation expansion of the reference image is performed (corresponding to S602 in FIG. 11). Examples of the method of interpolation expansion used herein include bi-linear interpolation and bi-cubic interpolation. The reference image that is subjected to interpolation expansion in the interpolation expansion unit 201 is, for example, sent to the image accumulation unit 202 as the initial image z₀, and is accumulated therein. Next, the reference image that was subjected to the interpolation expansion is supplied to the convolution unit 204, and is subjected to the convolution with the PSF data (corresponds to the image transformation matrix A of Expression (3)) that is supplied from the PSF data retention unit 203.

Moreover, the reference image, and a plurality of subject images for which the image displacement amount is estimated in the image displacement amount estimation processing (S110) are supplied to the registration image generation unit 205. Then, on the basis of the image displacement amount obtained in the image displacement amount estimation unit 20a, the registration image y is generated by performing the superposition processing in a coordinate space that is based on the expanded coordinates of the reference image (corresponds to S603 in FIG. 11). For example, in the superposition processing in the registration image generation unit 205, the pixel positions are matched between each pixel value of the plurality of images that was subjected to estimation of the image displacement amount in the image displacement amount estimation processing (S110), and the expanded coordinates of the reference image, so that each pixel value is set on the nearest lattice point of the expanded coordinates of the reference image. At this time, a plurality of pixel values may be set on the same lattice point. However, in this case, the averaging is performed to those pixel values.

The image data (vector) that was subjected to the convolution in the convolution unit 204 is sent to the image comparison unit 206. In the image comparison unit 206, the difference of the pixel values in the same pixel position is computed between the image data that was subjected to the convolution and the registration image y generated in the registration image generation unit 205, whereby the difference image data (corresponds to (y−Az) of Expression (3)) is generated. The difference image data generated in the image comparison unit 206 is supplied to the convolution unit 207 to thereby perform convolution with the PSF data supplied from the PSF data retention unit 203. The convolution unit 207, for example, performs convolution of the transposed matrix of the image transformation matrix A in Expression (3) and the column vector representing the difference image data, so as to generate a vector which was obtained by partially differentiating ∥y−Az∥² of Expression (3) with each element (component) of z.

Moreover, the image accumulated in the image accumulation unit 202 is supplied to the regularized term computation unit 208 where the regularized term g(z) in Expression (3) is obtained. The regularized term g(z) is partially differentiated with each element of z to thereby derive a vector ∂g(z)/∂z. For example, the regularized term computation unit 208 performs the color conversion processing from RGB to YCrCb for image data accumulated in the image accumulation unit 202, to thereby obtain a vector by executing convolution of a frequency highpass filter (Laplacian filter) to the YCrCb component (brightness component and color difference component). Then, the regularized term computation unit 208 uses the square norm (square of length) of the obtained vector as the regularized term g(z), to thereby derive a vector ∂g(z)/∂z by executing the partial differentiation of g(z) with each element of z. Although a component for false color is extracted by applying the Laplacian filter to Cr and Cb components (color difference components), it is possible to remove the component of false color by minimizing the regularized term g(z). Since the regularized term g(z) is included in Expression (3), an empirical rule relating to images, “A color difference component of an image generally changes smoothly.” is used. Therefore, it is possible to obtain stably the high-resolution image in which the color difference is suppressed.

The updated image generation unit 209 is provided with the image data (vector) generated in the convolution unit 207, the image data (vector) accumulated in the image accumulation unit 202, and the image data (vector) generated in the regularized term computation unit 208. In the updated image generation unit 209, these pieces of image data (vectors) are summed up after being multiplied by the weighting factors, such as λ and α shown in Expression (3) and Expression (4), whereby the updated high-resolution image is generated (corresponds to Expression (4)).

Thereafter, the high-resolution image updated in the updated image generation unit 209 is provided to the convergence determination unit 210, and the convergence is determined. In the convergence determination, it may be determined that the updating work of the high-resolution image is converged if the number of times of iteration computation needed for the convergence is more than a predetermined number of times. Moreover, the high-resolution image updated in the past may be recorded, and the difference with the present high-resolution image may be calculated as the update amount, and then it may be determined that the updating work of the high-resolution image is converged if the update amount is less than a fixed value.

If it is determined that the updating work is converged in the convergence determination unit 210, the updated high-resolution image is output to the exterior as a final high-resolution image. If it is determined that the updating work is not converged, the updated high-resolution image is provided to the image accumulation unit 202, and is used for the next updating work. The high-resolution image is provided to the convolution unit 204 and the regularized term computation unit 208 for the next updating work. The above processing is repeated and the high-resolution image is updated in the updated image generation unit 209, whereby it is possible to obtain a high-resolution image.

In the present embodiment, the earlier capture processing (S107) is performed while the shutter button 104 is half-pressed as the first stage capture instruction, and the later capture processing (S109) is performed after the shutter button 104 is fully-pressed as the second stage capture instruction. The image displacement amount between the subject image and the reference image is estimated by using an image captured immediately after the shutter button 104 is fully-pressed as the reference image. For this reason, the image displacement amount between the subject image and the reference image can be estimated in high accuracy, and it is possible to generate good high-resolution images.

Moreover, it is possible to estimate the image displacement amount between the subject image and the reference image in further higher accuracy because the capture of the image is halted until a time period considered as having a large amount of camera shake elapses, after performing one image capture (S401) immediately after the full-press in the later capture processing (S109).

### Second Embodiment

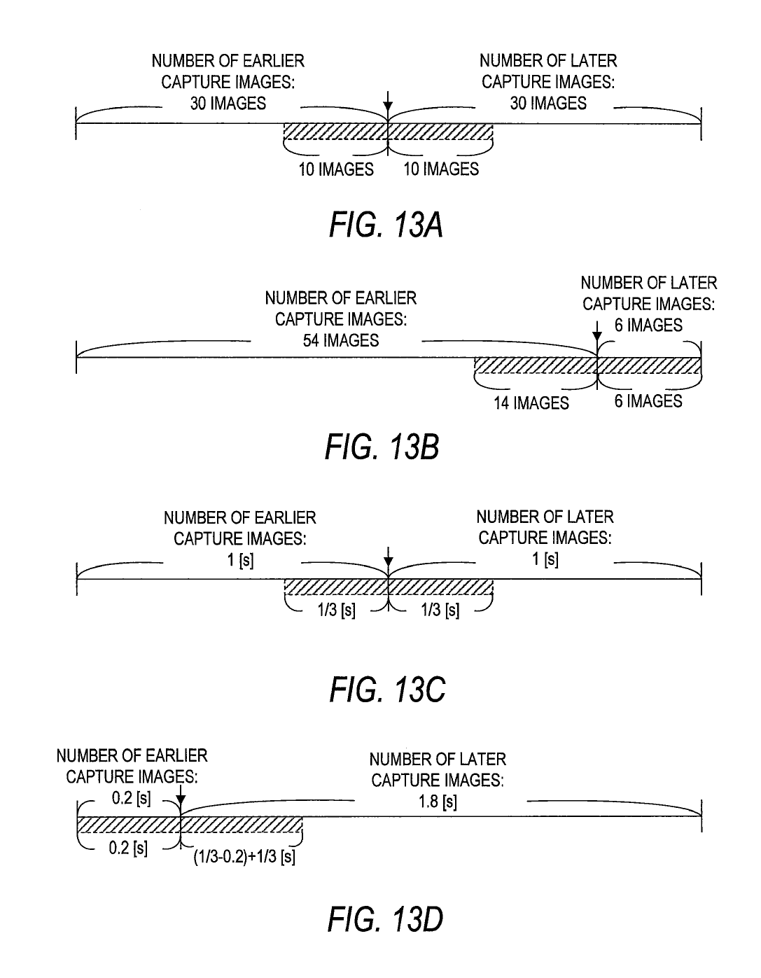

FIGS. 13A-13D depict views showing examples of a method for automatically determining a reference image in the imaging system according to the second embodiment of the present invention. The arrangement and the processing of the imaging system according to the present embodiment are similar to that of the imaging system according to the first embodiment except for the points shown below, and thus, only the different points will be described.

In FIG. 13A, the prescribed period is determined as a period during which a predetermined number of images are captured before and after fully-pressing the shutter button 104. One of the images captured in the prescribed period is set as a reference image, and the image displacement amount between each of a plurality of subject images and the reference image is estimated. Thereafter, the high-resolution processing (S111) and other processing are performed. In the example of FIG. 13A, the number of earlier capture images is 30, and the number of later capture images is 30. In the example of FIG. 13A, the prescribed period is determined as a period during which a total of 20 images, that is, 10 images before the shutter button 104 is fully-pressed and 10 images after it is fully-pressed, are captured. A reference image is determined among those 20 images.

In FIG. 13B, the prescribed period is determined as a period during which a predetermined number of images are captured before and after the time the shutter button 104 is fully-pressed, as in FIG. 13A. However, since the number of later capture images is 6, the prescribed period is determined as a period during which a total of 20 images, that is, 14 images before the shutter button 104 is fully-pressed and 6 images after it is fully-pressed, are captured. A reference image is determined among those 20 images.

In FIG. 13C, the prescribed period is determined as a period having a predetermined length of time and including before and after a time when the shutter button 104 is fully-pressed. One of the images captured in the prescribed period is used as the reference image, and the image displacement amount between each of the plurality of subject images and the reference image is estimated. Thereafter, the high-resolution processing (S111) and others are performed. In the example of FIG. 13C, the time period for performing the earlier capture processing (S107) is 1 second, and the time period for performing the later capture processing (S109) is 1 second. The prescribed period is a total of ⅔ second, that is, ⅓ second before the shutter button 104 is fully-pressed, and ⅓ second after it is fully-pressed. A reference image is determined among the images captured during this 2/3 second. Here, for example, in cases where the frame rate of the imaging system is 30 fps, the number of images which can be captured during the 1/3 second is 10 images.

In FIG. 13D, the prescribed period is determined as a period having a predetermined length of time and including before and after the time when the shutter button 104 is fully-pressed, as in FIG. 13C. However, since there is only 0.2 second to perform the earlier capture processing (S107), the prescribed period is set as a total of 2/3 second, that is, 0.2 second before the shutter button 104 is fully-pressed and ((⅓−0.2)+⅓) second after it is fully-pressed. A reference image is determined among the images captured in this ⅔ second. With regards to the advantageous effects, it is similar to that of the imaging system according to the first embodiment.

### Third Embodiment

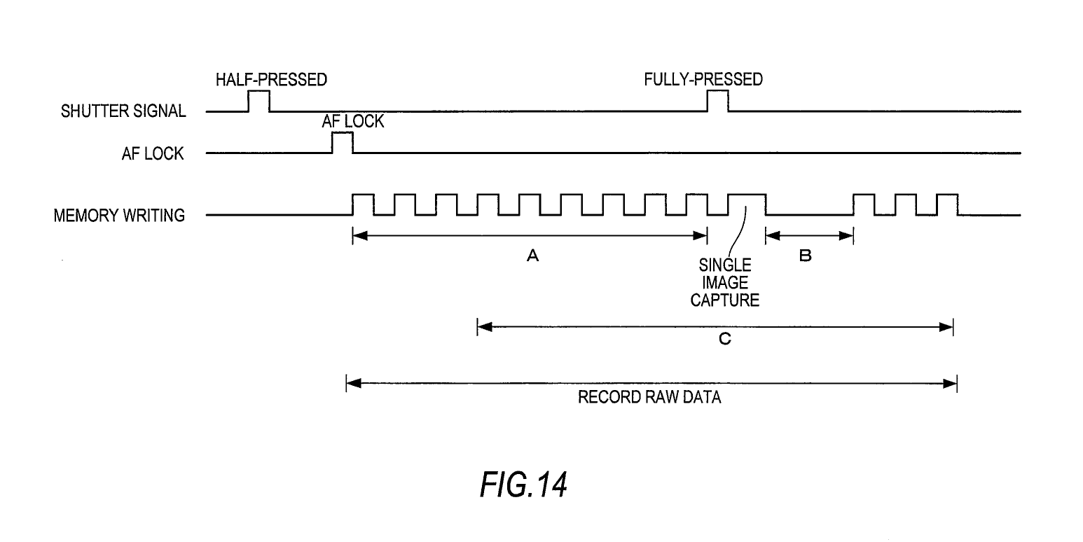

FIG. 14 depicts a view showing a processing sequence of the imaging system according to the third embodiment of the present invention. The arrangement and the processing of the imaging system according to the present embodiment are similar to that of the imaging systems according to the first and second embodiments except for the points shown below, and thus, only the different points will be described.

In the present embodiment, as shown in FIG. 14, image data of images captured in the earlier capture processing (S107) and the later capture processing (S109) is recorded in the buffer memory 13 as RAW data which has not undergone image processing. The buffer memory 13 circular-records (refer to the first embodiment) image data of images captured in the earlier capture processing (S107) as RAW data. Moreover, in the present embodiment, the switching unit 8 records directly into the buffer memory 13 image data of images captured in the earlier capture processing (S107) and the later capture processing (S109) as RAW data without modification. Thereby, it is possible to use RAW data which is suitable for the high-resolution processing (S111) in the high-resolution processing unit 20b. With respect to other advantageous effects, they are similar to that of the imaging systems according to the first and the second embodiments.

### Fourth Embodiment

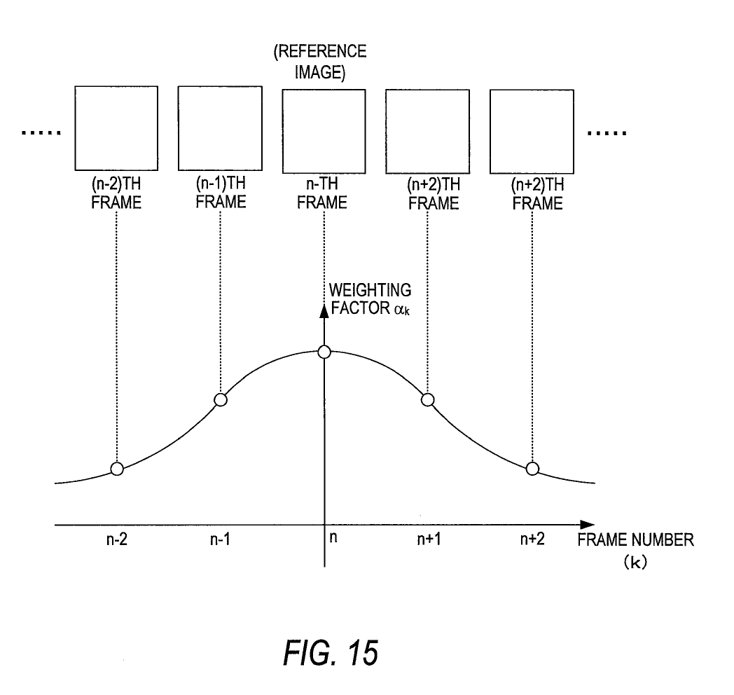

FIG. 15 depicts a view illustrating the high-resolution processing in the imaging system according to the fourth embodiment of the present invention. The arrangement and the processing of the imaging system according to the present embodiment are similar to that of the imaging systems according to the first to the third embodiments except for the points shown below, and thus, only the different points will be described.

In the present embodiment, instead of generating the registration image y, high-resolution processing (equivalent to the high-resolution processing S111 of the first embodiment) is performed using image data yₖ of the plurality of images captured in the earlier capture processing (S107) and the later capture processing (S109). Upon the processing, weighting is performed to the plurality of images captured in the earlier capture processing (S107) and the later capture processing (S109). The evaluation function f(z) in the present embodiment is represented by the following Expression (5).

f(z)={aₖ∥yₖ−Aₖz∥²λg(z)} (5)

In Expression (5), yₖ indicates a column vector representing image data of an image (low resolution image) captured in k-th order in the earlier capture processing (S107) and the later capture processing (S109), aₖ indicates a weighting factor for each low resolution image, z indicates a column vector representing image data of a high-resolution image that was subjected to high resolution processing of the target image, and Aₖ indicates an image conversion matrix representing characteristics of the imaging system including motions between the images, PSF, and the like. In the present embodiment, Aₖ is computed using the image displacement amount estimated in the image displacement amount estimation processing (S110), whereby it is possible to perform a registration (alignment) of the target image and the low resolution image. Moreover, g(z) indicates a regularized term which takes into consideration the smoothness of the image, correlation of color of the image, and the like, and λ indicates a weighting factor. In the present embodiment, as in the first embodiment, the high-resolution image z which provides the minimum evaluation function f(z) represented by Expression (5) is obtained using a steepest descent method and the like.

In the present embodiment, as shown in FIG. 15, a higher weight is given to an image captured at a time closer to the time when the shutter button 104 is fully-pressed (immediately before the reference image is captured). For example, in cases where n-th frame of the low resolution image (reference image) is to be subjected to high-resolution processing, the closer the frame is to the n-th frame, the value of the weighting factor aₖ is set larger. The value of the weighting factor aₖ may be varied in a Gaussian distribution, as shown in FIG. 15. Otherwise, as for the frame within a predetermined range close to the reference image, a fixed weight that is larger than other frames may be set.

In the present embodiment, since the weighting is performed such that the image captured at a time closer to the time when the reference image is captured is set larger weight, it is possible to generate a good high-resolution image using an image that is considered as having high degree of similarity with the reference image. With respect to other advantageous effects, they are similar to that of the imaging systems according to the first to the third embodiments.

### Fifth Embodiment

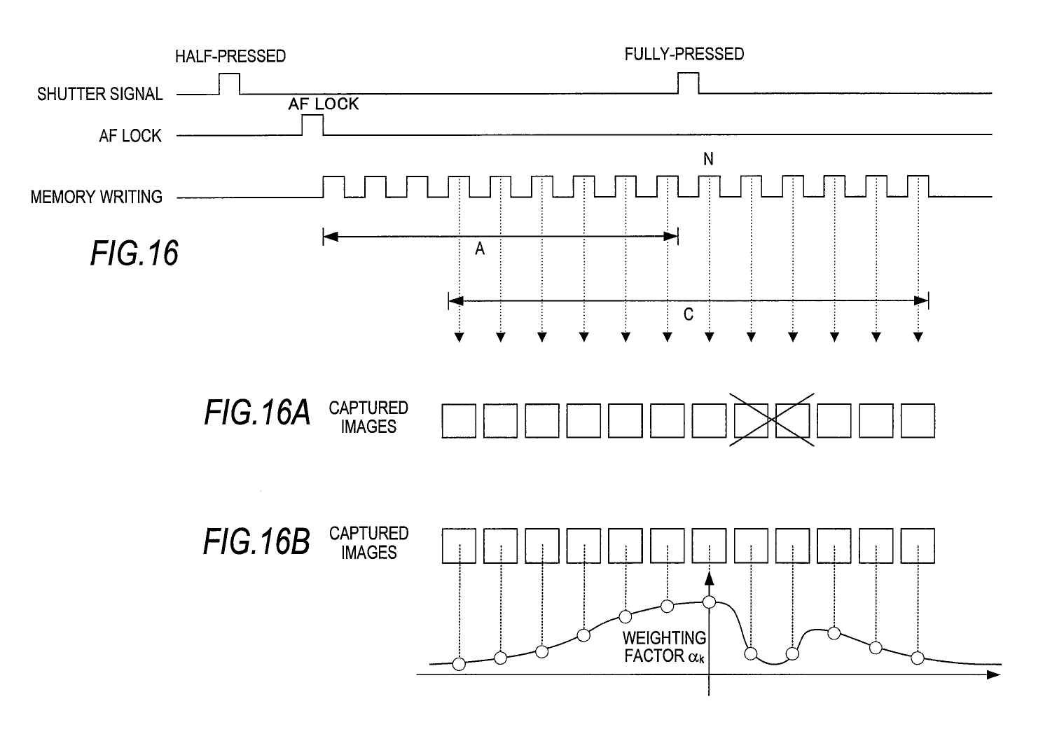

FIG. 16 depicts a view showing a processing sequence of the imaging system according to the fifth embodiment of the present invention. The arrangement and the processing of the imaging system according to the present embodiment are similar to that of the imaging systems according to the first to the fourth embodiments except for the points shown below, and thus, only the different points will be described.

In the present embodiment, image capturing is not halted in the later capture processing (S109 of the first embodiment), and a plurality of images are continuously captured as in the earlier capture processing (S107 of the first embodiment). Further, an image captured immediately after fully-pressing the shutter button 104 (N of FIG. 16) is used as the reference image. In the example of FIG. 16A, the high-resolution processing is performed by excluding a predetermined number of images (two images in FIG. 16) captured after a reference image is captured. As for the image that is not used for the high-resolution processing, it is not necessary to perform the image displacement amount estimation processing (S110).

Moreover, in the example of FIG. 16B, the high-resolution processing that uses the weighting according to the fourth embodiment is performed (refer to Expression (5)). The weighting factor aₖ of a predetermined number of images (two images in FIG. 16B) captured after the reference image is set small.

In the present embodiment, a predetermined number of images that are captured after the shutter button 104 is fully-pressed and are considered as experiencing a large amount of camera shake, are excluded or discriminated so as to perform the high-resolution processing, and therefore, it is possible to generate a good high-resolution image. With respect to other advantageous effects, they are similar to that of the imaging systems according to the first to the fourth embodiments.

### Sixth Embodiment

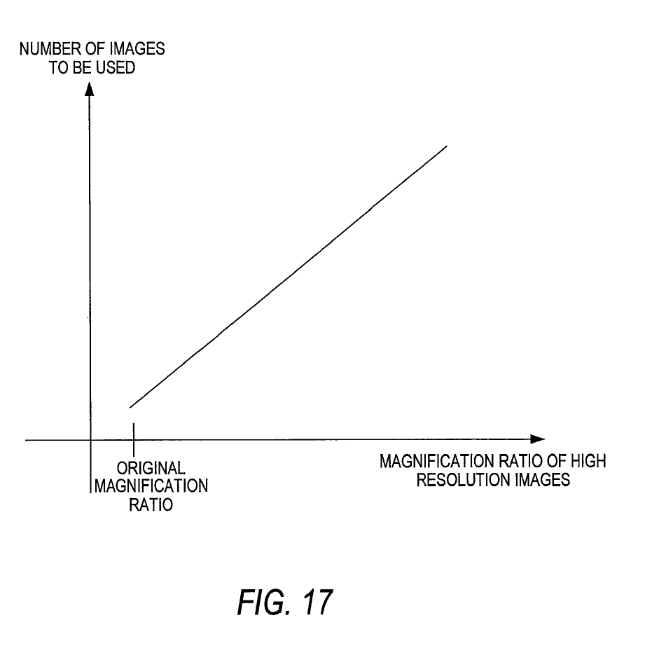

FIG. 17 depicts a graph showing a relationship between the magnification ratio of the high-resolution image and the number of images to be used in the high-resolution processing in the imaging system according to the sixth embodiment of the present invention. The arrangement and the processing of the imaging system according to the present embodiment are similar to that of the imaging systems according to the first to the fifth embodiments except for the points shown below, and thus, only the different points will be described.

In the present embodiment, among the plurality of images captured in the earlier capture processing (S107) and the later capture processing (S109), the number of images used for the high-resolution processing is automatically set according to the magnification ratio (ratio of the resolution compared to the original image) of the high-resolution image to be generated. At this time, as shown in FIG. 17, the larger the magnification of the high-resolution image, the larger the number of images is set to be used for the high-resolution processing.

Moreover, for example, instead of the number-of-capture-images setting (S101) of the first embodiment, the user sets the magnification ratio of the high resolution image, so that the number of images required for the generation of the high-resolution image is calculated, whereby that number of images are captured in the earlier capture processing (S107) and the later capture processing (S109). At this time, the numbers of images for the images captured in the earlier capture processing (S107) and the later capture processing (S109) may be calculated separately.

In the present embodiment, the high-resolution processing using the images of the number according to the magnification ratio of the high-resolution image, and therefore, it is possible to generate a good high-resolution image. With respect to other advantageous effects, they are similar to that of the imaging systems according to the first to the fifth embodiments.

### Seventh Embodiment

The imaging system according to the present embodiment performs the earlier capture processing (S107) and the later capture processing (S109) with an imaging apparatus, such as a digital still camera, and performs the image displacement amount estimation processing (S110) and the high-resolution processing (S111) with an image processing apparatus, such as a personal computer. The image processing program is stored in a computer-readable storage medium. The program is encoded and saved in a computer-readable format. The computer has a microprocessor and a memory. The program includes a program code (command) for causing the computer to perform the above-described processing. The arrangement and the processing of the other imaging systems are the same as that of one imaging system of the first to the sixth embodiment. In cases where the image capture and the image processing are performed in separate apparatuses as in the present embodiment, it is necessary to transfer or input to the image processing system the image data to be used in the image displacement amount estimation processing (S110) and the high-resolution processing (S111), information as to which image is set as the reference image, and the like. Moreover, in cases where high-resolution processing using the weighting is performed as in the fourth embodiment, it is required to give the information on the weighting factor, and the like to the image processing apparatus. With regards to the advantageous effects, they are similar to any of the imaging systems of the first to the sixth embodiments.

The present invention is not limited to the above-described embodiments, and obviously includes various changes and improvements made within the scope of the technical idea. For example, in the first to the sixth embodiments, the half-pressing of the shutter button 104 is described as the example of the first stage capture instruction that starts the earlier capture processing (S107), and the full-press of the shutter button 104 is described as the example of the second stage capture instruction that starts the later capture processing (S109). However, the input of the first stage and the second stage capture instructions may be done by other techniques. Moreover, in the first to the sixth embodiments, the super-resolution processing is used as the method of subjecting the reference image to the high-resolution processing. However, instead of the high-resolution processing using the super-resolution processing, image processing, such as estimating the image displacement amount of the images captured in the earlier capture processing (S107) and in the later capture processing (S109) and then obtaining the weighted average by superposing the images, to thereby reduce the random noise.

What is claimed is:

1. An imaging system which captures an image and generates image data of the image, comprising:
a capture instruction input unit through which a first stage capture instruction and a following second stage capture instruction are input;
a capture unit which performs earlier capture processing for capturing a plurality of images during a period from when the first stage capture instruction is input and until the second stage capture instruction is input, and performs later capture processing for capturing a plurality of images after the second stage capture instruction is input; and
an image displacement amount estimation unit which estimates an image displacement amount between a reference image and each of the plurality of images captured in the earlier capture processing and the later capture processing, using one of the images captured during a prescribed period which is a predetermined period including before and after the second stage capture instruction is input, as the reference image.

2. The imaging system according to claim 1, further comprising:
a high-resolution processing unit which generates a high-resolution image that has a resolution higher than the images captured in the earlier capture processing and the later capture processing, by using the image displacement amount which is estimated by the image displacement amount estimation unit, and the plurality of images captured in the earlier capture processing and the later capture processing.

3. The imaging system according to claim 2, wherein the high-resolution processing unit includes a weighting unit which performs weighting onto the plurality of images captured in the earlier capture processing and the later capture processing upon generating the high-resolution image, and
the weighting unit performs the weighting such that a higher weight is given to an image captured at a time closer to the time when the second stage capture instruction is input.

4. The imaging system according to claim 2, wherein the high-resolution processing unit generates the high-resolution image, excluding a predetermined number of images among the plurality of images captured in the later capture processing.

5. The imaging system according to claim 2, wherein the high-resolution processing unit generates the high-resolution image, by discriminating a predetermined number of images among the plurality of images captured in the later capture processing upon the processing.

6. The imaging system according to claim 2, wherein the high-resolution processing unit includes a usage number setting unit which sets either of a number of images to be used for generation of the high-resolution image, and a number of images to be captured in the earlier capture processing and the later capture processing, according to the magnification ratio of the high-resolution image.

7. The imaging system according to claim 1, wherein the capture unit stops capture of the image until a predetermined time period elapses after capturing a predetermined number of images in the later capture processing.

8. The imaging system according to claim 1, wherein the image displacement amount estimation unit uses an image captured first after the second stage capture instruction is input as the reference image.

9. The imaging system according to claim 1, further comprising:
a circular recording unit which is capable of recording image data of a predetermined number of images among the plurality of images captured in the earlier capture processing, and which circular-records image data of the predetermined number of images while overwriting image data of an old image with image data of a new image,
wherein the circular recording unit records image data of the images captured in the earlier capture processing and the later capture processing as RAW data which has not undergone image processing.

10. The imaging system according to claim 1, wherein the prescribed period is determined as a period having a predetermined length of time and including before and after a time when the second stage capture instruction is input.

11. The imaging system according to claim 1, wherein the prescribed period is determined as a period during which a predetermined number of images are captured before and after a time when the second stage capture instruction is input.

12. A computer readable storage medium storing an imaging program, wherein the imaging program instructs a computer to execute a method comprising:
an image data acquisition step of acquiring image data of a plurality of images from an imaging system which captures the plurality of images before and after a shutter button is fully-pressed;
a reference image determination step of automatically determining a reference image from the images captured in a prescribed period which is a predetermined period including before and after a time when the shutter button is fully-pressed; and
an image displacement amount estimation step of estimating an image displacement amount between the reference image and each of the plurality of images captured before and after the shutter button is fully-pressed.
